(19) United States
(12) Patent Application Publication
(10) Pub. No.: US 2026/0088971 A1
(43) Pub. Date: Mar. 26, 2026

(54) ACCESS CONTROL AND PROTECTION OF TELEMETRY SIGNALS USING ATTRIBUTE-BASED ENCRYPTION

(71) Applicant: INTERNATIONAL BUSINESS MACHINES CORPORATION, Armonk, NY (US)

(72) Inventors: Patrick Aaron Tamborski, Chicago, IL (US); Mark Duane Seaborn, Algonquin, IL (US)

(21) Appl. No.: 18/896,047

(22) Filed: Sep. 25, 2024

(51) Int. Cl. H04L 9/06; H04L 9/14

(52) U.S. Cl. CPC H04L 9/0618; H04L 9/14

(57) ABSTRACT

A system, method and computer program product are configured to: receive, at a telemetry backend, a request for telemetry data from a user, the request including an attribute-based encryption (ABE) ciphertext associated with the user; attempt to decrypt the ABE ciphertext using plural different ABE decryption keys; successfully decrypt the ABE ciphertext using a respective one of the plural different ABE decryption keys; and based on the successfully decrypting the ABE ciphertext using the respective one of the plural different ABE decryption keys, provide the user with access to telemetry data stored in a respective one of plural storage partitions associated with the respective one of the plural different ABE decryption keys, wherein the telemetry data stored in the respective one of plural storage partitions includes the telemetry data requested by the user.

### BACKGROUND

Aspects of the present invention relate generally to distributed computing systems and, more specifically, to systems and methods of providing access control to data in distributed computing systems.

In computer systems security, role-based access control (RBAC) is an approach to restricting system access to authorized users, and to implementing mandatory access control (MAC) or discretionary access control (DAC). RBAC is a policy-neutral access control mechanism defined around roles and privileges. The components of RBAC such as role-permissions, user-role and role-role relationships make it simple to perform user assignments. RBAC can be used to facilitate administration of security in large organizations with hundreds of users and thousands of permissions.

In a first aspect of the invention, there is a computer-implemented method including: receiving, by a processor set, a request for telemetry data from a user, the request including an attribute-based encryption (ABE) ciphertext associated with the user; attempting to decrypt the ABE ciphertext, by the processor set, using plural different ABE decryption keys; and based on successfully decrypting the ABE ciphertext using a respective one of the plural different ABE decryption keys, providing, by the processor set, the user with access to telemetry data stored in a respective one of plural storage partitions associated with the respective one of the plural different ABE decryption keys, wherein the telemetry data stored in the respective one of plural storage partitions includes the telemetry data requested by the user.

In another aspect of the invention, there is a computer program product including one or more computer readable storage media having program instructions collectively stored on the one or more computer readable storage media. The program instructions are executable to: receive, at a telemetry backend, a request for telemetry data from a user, the request including an attribute-based encryption (ABE) ciphertext associated with the user; attempt to decrypt the ABE ciphertext using plural different ABE decryption keys; successfully decrypt the ABE ciphertext using a respective one of the plural different ABE decryption keys; and based on the successfully decrypting the ABE ciphertext using the respective one of the plural different ABE decryption keys, provide the user with access to telemetry data stored in a respective one of plural storage partitions associated with the respective one of the plural different ABE decryption keys, wherein the telemetry data stored in the respective one of plural storage partitions includes the telemetry data requested by the user.

In another aspect of the invention, there is a system including a processor set, one or more computer readable storage media, and program instructions collectively stored on the one or more computer readable storage media. The program instructions are executable to: receive, at a telemetry backend, a request for telemetry data from a user, the request including an attribute-based encryption (ABE) ciphertext associated with the user; attempt to decrypt the ABE ciphertext using plural different ABE decryption keys; successfully decrypt the ABE ciphertext using a respective one of the plural different ABE decryption keys; and based on the successfully decrypting the ABE ciphertext using the respective one of the plural different ABE decryption keys, provide the user with access to telemetry data stored in a respective one of plural storage partitions associated with the respective one of the plural different ABE decryption keys, wherein the telemetry data stored in the respective one of plural storage partitions includes the telemetry data requested by the user.

Aspects of the present invention relate generally to distributed computing systems and, more specifically, to systems and methods of providing access control and protection of telemetry signals using attribute-based encryption. Telemetry signals (referred to herein as telemetry data), are pieces of information of measurements that can be used for monitoring and troubleshooting the performance of applications and platforms in distributed computing systems. A key part of successful application performance is having observability through access to data. Information technology (IT) professionals use telemetry data to determine the health and performance of applications and platforms. Telemetry data is composed primarily of outputs that are collected from logs, metrics and traces. These are often referred to as the three pillars of observability. Collecting, processing, and analyzing telemetry data from distributed applications and systems has become of great importance to enterprises for efficiently managing or troubleshooting their distributed computing systems. Software of all kinds can be instrumented in such a way that telemetry data is generated about the performance of a flow, operation, function, end-to-end network request, service call, etc.

A telemetry pipeline may comprise a set of services, components, and/or functions that ingest telemetry data, optionally transform the telemetry data, and ultimately send the telemetry data to a telemetry backend (or another pipeline). A telemetry backend may comprise a service or set of services that is responsible for post-processing and viewing received telemetry data. A telemetry backend may be a cloud provider, on-premise solution, or some combination of both. A telemetry backend may be configured to generate backend data including visualizations (e.g., dashboards), reports, and alerts based on the received telemetry data. Typically, this backend data can be introspected by human administrators via a client computing device for general purpose monitoring, observing, and understanding of overall system performance. In some examples, the backend data is passed to an automated tool for automated analysis. For example, automated analysis may include analyzing portions of telemetry data, e.g., using machine learning algorithms, to identify patterns in the data associated with an incident. Identifying such patterns is useful in developing remediation actions (e.g., patches, rules, processes, configurations, etc.) aimed at avoiding future occurrences of the incident. This type of analysis can comprise automated root cause analysis (RCA) that uses machine learning to determine a cause of the incident by analyzing portions of the telemetry data.

There is a need for enterprises to implement fine-grained access control for viewing telemetry data. For example, an organizational structure or law may require constraints to be satisfied before telemetry data containing potentially sensitive information is viewed or processed. Such potentially sensitive information may include, for example, classified information, personally identifiable information (PII), and other types of sensitive information.

Implementations of the invention address this need by using attribute-based encryption (ABE) to implement an access control system for telemetry data. ABE is a particular type of public-key encryption in which a secret cryptographic key and a ciphertext are dependent upon attributes, such as, for example, the geographic location where a user works, job title of the user, job roles of the user, resource group the user is a member of, security level of the user, and the like. In attribute-based encryption, the decryption of the ciphertext is possible only if the set of attributes of the key matches the attributes of the ciphertext. There are two main types of attribute-based encryption techniques: key-policy attribute-based encryption (KP-ABE); and ciphertext-policy attribute-based encryption (CP-ABE).

Various embodiments utilize classification of telemetry data as policy attributes for controlling access to the telemetry data via a telemetry backend. In particular embodiments, a telemetry pipeline is enhanced such that classifications of telemetry data are encrypted using respective ABE encryption keys for respective ones of the defined classifications of telemetry data. In embodiments, a set of microservices, functions, or a monolithic application in the telemetry backend decrypts specific incoming telemetry messages and associates each telemetry message with a respective partition based on the decryption. In one example, a telemetry authority service that is decoupled from the telemetry backend assigns ciphertext (or keys) to each defined user, such that each user is granted access to the telemetry data in one or more of the respective partitions based on the user’s assigned ciphertext. In this manner, the telemetry backend does not need to be access policy aware. Systems and methods described herein have the advantage of eliminating the need for a separate authentication and access control that is dependent on a vendor supplying the telemetry backend. Another advantage provided by embodiments is that permission to view telemetry data is encoded alongside the telemetry data itself. A further advantage provided by embodiments is that the access control policy is hidden from the telemetry backend (e.g., the telemetry backend may be aware of the classifications of telemetry data and which users can view the telemetry data associated with ones of the classification, but the telemetry backend cannot discern why a user has such access). An even further advantage provided by embodiments is that the telemetry data itself can be hidden from users while it remains at rest, such as when it is cached on the telemetry backend. In this manner, implementations of the invention provide an improvement in the technology of computer-based access control, particularly as pertaining to computer-based access control to telemetry data received from a telemetry pipeline.

In accordance with aspects of the invention, there is a computer-implemented method, comprising: receiving, by a processor set, a request for telemetry data from a user, the request including an attribute-based encryption (ABE) ciphertext associated with the user; attempting to decrypt the ABE ciphertext, by the processor set, using plural different ABE decryption keys; and based on successfully decrypting the ABE ciphertext using a respective one of the plural different ABE decryption keys, providing, by the processor set, the user with access to telemetry data stored in a respective one of plural storage partitions associated with the respective one of the plural different ABE decryption keys, wherein the telemetry data stored in the respective one of plural storage partitions includes the telemetry data requested by the user. In this manner, implementations of the invention provide the advantage of providing role-based access control to telemetry data using attribute-based encryption. This has the further advantage of eliminating the need for a separate authentication and access control that is dependent on a vendor supplying the telemetry backend.

In embodiments of the method, the request is received via a user interface of a telemetry backend, and the user is provided access to the telemetry data stored in the respective one of plural storage partitions via the telemetry backend. This has the advantage of enforcing the role-based access control via a telemetry backend that is accessed by user seeking access to the telemetry data.

In embodiments of the method, the telemetry backend is associated with a telemetry pipeline. This provides the advantages attendant to a telemetry pipeline, including collecting telemetry data from plural different sources and processing of the telemetry data prior to the telemetry backend.

In embodiments of the method, the telemetry backend is configured to: receive encrypted telemetry data from the telemetry pipeline; attempt to decrypt the encrypted telemetry data using the plural different ABE decryption keys; and based on successfully decrypting the encrypted telemetry data using the respective one of the plural different ABE decryption keys, store the decrypted telemetry data in the respective one of the plural storage partitions. This has the advantage of using ABE for providing fine-grained access control for plural different users to access plural different types of telemetry data.

In embodiments of the method, the telemetry pipeline is configured to create the encrypted telemetry data by encrypting extracted telemetry data using one of plural different ABE encryption keys. This has the advantage of using ABE for providing fine-grained access control for plural different types of telemetry data according to classifications of the telemetry data.

In embodiments of the method, the ABE authority service creates the ABE ciphertext and provides the ABE ciphertext to the user, the ABE authority service creates the plural different ABE decryption keys and provides the plural different ABE decryption keys to the telemetry backend, and the ABE authority service creates the plural different ABE encryption keys and provides the plural different ABE encryption keys to the telemetry pipeline. This has the advantage of the telemetry pipeline and the telemetry backend not needing to be aware of the access control policies.

In embodiments of the method, the ABE authority service is separate from the telemetry backend and the telemetry pipeline. This has the advantage of the access control policy is hidden from the telemetry pipeline and the telemetry backend (e.g., the telemetry backend may be aware of the classifications of telemetry data and which users can view the telemetry data associated with ones of the classification, but the telemetry backend cannot discern why a user has such access).

In some embodiments of the method, the telemetry pipeline is configured to encrypt the extracted telemetry data using ciphertext-policy attribute-based encryption. This has the advantage of enforcing access control based on a user having access to all classifications of the telemetry data.

In other embodiments of the method, the telemetry pipeline is configured to encrypt the extracted telemetry data using key-policy attribute-based encryption. This has the advantage of enforcing access control based on a user having access to a subset of all classifications of the telemetry data.

In embodiments of the method, the telemetry pipeline is configured to encrypt the extracted telemetry data using the one of the plural different ABE encryption keys based on identifying a classification of the extracted telemetry data. This has the advantage of providing access control to telemetry data using ABE and based on a determined classification of the telemetry data.

In embodiments of the method, each of the plural different ABE decryption keys contains a respective one of plural classifications of telemetry data. This has the advantage of providing fine-grained access control based on plural different classifications of telemetry data.

In embodiments of the method, the ABE ciphertext associated with the user contains an authorization policy defined for the user in terms of attributes associated with the user. This has the advantage of providing role-based access control to telemetry data for users based on attributes of the users.

In accordance with another aspects, there is a computer program product comprising one or more computer readable storage media having program instructions collectively stored on the one or more computer readable storage media, the program instructions executable to: receive, at a telemetry backend, a request for telemetry data from a user, the request including an attribute-based encryption (ABE) ciphertext associated with the user; attempt to decrypt the ABE ciphertext using plural different ABE decryption keys; successfully decrypt the ABE ciphertext using a respective one of the plural different ABE decryption keys; and based on the successfully decrypting the ABE ciphertext using the respective one of the plural different ABE decryption keys, provide the user with access to telemetry data stored in a respective one of plural storage partitions associated with the respective one of the plural different ABE decryption keys, wherein the telemetry data stored in the respective one of plural storage partitions includes the telemetry data requested by the user. In this manner, implementations of the invention provide the advantage of providing role-based access control to telemetry data using attribute-based encryption. This has the further advantage of eliminating the need for a separate authentication and access control that is dependent on a vendor supplying the telemetry backend.

In embodiments, each of the plural different ABE decryption keys contains a respective one of plural classifications of telemetry data. This has the advantage of providing fine-grained access control based on plural different classifications of telemetry data.

In embodiments, the telemetry backend is configured to receive encrypted telemetry data from a telemetry pipeline, the encrypted telemetry data being encrypted using one of plural different ABE encryption keys based on one of the plural classifications of telemetry data. This has the advantage of providing access control to telemetry data using ABE and based on a determined classification of the telemetry data. This has the advantage of providing fine-grained access control based on plural different classifications of telemetry data.

In embodiments, the ABE ciphertext associated with the user contains an authorization policy defined for the user in terms of attributes associated with the user. This has the advantage of providing role-based access control to telemetry data for users based on attributes of the users.

In accordance with aspects, there is a system comprising a processor set, one or more computer readable storage media, and program instructions collectively stored on the one or more computer readable storage media. The program instructions are executable to: receive, at a telemetry backend, a request for telemetry data from a user, the request including an attribute-based encryption (ABE) ciphertext associated with the user; attempt to decrypt the ABE ciphertext using plural different ABE decryption keys; successfully decrypt the ABE ciphertext using a respective one of the plural different ABE decryption keys; and based on the successfully decrypting the ABE ciphertext using the respective one of the plural different ABE decryption keys, provide the user with access to telemetry data stored in a respective one of plural storage partitions associated with the respective one of the plural different ABE decryption keys, wherein the telemetry data stored in the respective one of plural storage partitions includes the telemetry data requested by the user. In this manner, implementations of the invention provide the advantage of providing role-based access control to telemetry data using attribute-based encryption. This has the further advantage of eliminating the need for a separate authentication and access control that is dependent on a vendor supplying the telemetry backend.

In embodiments, each of the plural different ABE decryption keys contains a respective one of plural classifications of telemetry data. This has the advantage of providing fine-grained access control based on plural different classifications of telemetry data.

In embodiments, the telemetry backend is configured to receive encrypted telemetry data from a telemetry pipeline, the encrypted telemetry data being encrypted using one of plural different ABE encryption keys based on one of the plural classifications of telemetry data. This has the advantage of providing access control to telemetry data using ABE and based on a determined classification of the telemetry data. This has the advantage of providing fine-grained access control based on plural different classifications of telemetry data.

In embodiments, the ABE ciphertext associated with the user contains an authorization policy defined for the user in terms of attributes associated with the user. This has the advantage of providing role-based access control to telemetry data for users based on attributes of the users.

Implementations of the invention are necessarily rooted in computer technology. For example, the steps of encrypting and decrypting telemetry messages is computer-based and cannot be performed in the human mind. In embodiments, computer-based encryption algorithms are used encrypt a telemetry message in real time or near real time (e.g., within a matter of milliseconds or microseconds), and computer-based decryption algorithms are used decrypt an encrypted telemetry message in real time or near real time (e.g., within a matter of milliseconds or microseconds). The number and complexity of operations performed by such computer-based encryption algorithms and decryption algorithms cannot be reasonably be performed in the human mind, or with pen and paper, in real time or near real time.

It should be understood that, to the extent implementations of the invention collect, store, or employ personal information provided by or obtained from individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, con, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as telemetry signal access control code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 105, 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 2 shows an exemplary telemetry handling environment 200 including a telemetry pipeline 205 and a telemetry backend 210. The telemetry pipeline 205 receives telemetry data from various distributed computing sources including but not limited to hosted applications 220, computing clusters 225, and cloud workloads 230. The telemetry pipeline 205 receives telemetry data via one or more collectors 240. The telemetry pipeline 205 processes the received telemetry data using one or more processors 245, wherein the processing is performed to meet visual, automated, and/or analytical requirements. The telemetry pipeline 205 exports the processed telemetry data using one or more exporters 250 that are configured to send the data to a destination such as the telemetry backend 210 which may be one of plural different telemetry backends. The telemetry pipeline 205 may be implemented as a monolithic application or as a service-oriented architecture. In one example, the one or more collectors 240, the one or more processors 245, and the one or more exporters 250 are implemented as microservices in a service-oriented architecture. The telemetry pipeline 205 may transmit the telemetry data to the telemetry backend 210 via a network 255. The telemetry backend 210 may be configured to generate backend data including visualizations (e.g., dashboards), reports, and alerts based on the received telemetry data. This backend data can be introspected by human user 265, e.g., via a client computing device, for general purpose monitoring, observing, and understanding of overall system performance of the various sources 220, 225, and 230.

FIG. 3 shows an exemplary telemetry handling environment 300 in accordance with aspects of the present invention. The telemetry handling environment 300 includes a telemetry pipeline 305 that communicates with a telemetry backend 310 via a network 355. There may be any number of telemetry backends 310, each comprising a service or set of services running on a computer device and configured to generate backend data as described herein. In embodiments, the telemetry pipeline 305 receives telemetry data from various distributed computing sources including but not limited to hosted applications 320, computing clusters 325, and cloud workloads 330. In various examples, the telemetry data is automatically generated by one or more system monitoring tools that monitor one or more of the sources 320, 325, and 330, and includes at least one of logs, metrics, and traces. Logs are files that record events, warnings, and errors as they occur within a software environment. Metrics are quantifiable measurements that reflect the health and performance of applications or infrastructure. A trace is data that tracks an application request as it flows through the various parts of an application.

In embodiments the telemetry pipeline 305 includes one or more collectors 340, one or more processors 345, one or more exporters 350, and a telemetry ABE encryptor 370. The one or more collectors 340 are configured to collect telemetry data from one or more of the sources 320, 325, and 330 and pass the collected telemetry data to the one or more processors 345. The one or more processors 345 are configured to process the telemetry data, for example, by adjusting or modifying the telemetry data to meet visual, automated, and/or analytical requirements. The one or more exporters 350 are configured to receive the processed telemetry data from the one or more processors 345 and provide the processed telemetry data to the telemetry ABE encryptor 370. In accordance with aspects of the invention, the telemetry ABE encryptor 370 is configured to determine a classification of telemetry data, encrypt the telemetry data using a respective ABE encryption key based on the determined classification, and transmit the encrypted telemetry data to the telemetry backend 310. The telemetry pipeline 305 may be implemented as a monolithic application or as a service-oriented architecture. In one example, the one or more collectors 340, the one or more processors 345, the one or more exporters 350, and the telemetry ABE encryptor 370 are implemented as microservices in a service-oriented architecture.

With continued reference to FIG. 3, and in accordance with aspects of the present invention, the telemetry backend 310 comprises or communicates with a telemetry ABE decryptor 375. In embodiments, the telemetry ABE decryptor 375 is configured to receive the encrypted telemetry data from the telemetry ABE encryptor 370 and attempt to decrypt the encrypted telemetry data using plural decryption keys. The telemetry ABE decryptor 375 is further configured to, upon successfully decrypting the encrypted telemetry data using a respective one of the plural decryption keys, store the decrypted telemetry data in a respective one a plural storage partitions 385a-c associated with the respective one of the plural decryption keys. In this manner, different classifications of telemetry data are stored in different ones of the storage partitions 385a-c based on the classifications.

Still referring to FIG. 3, and in accordance with additional aspects of the present invention, the telemetry backend 310 is configured to receive a request for telemetry data from a user via a client device 365, wherein the request includes an attribute-based encryption (ABE) ciphertext associated with the user. The client device 365 may comprise one or more of the EUD 103 of FIG. 1. In embodiments, the telemetry ABE decryptor 375 is configured to use the ciphertext from the user and the plural decryption keys to determine a respective one of the storage partitions 385a-c that the user has authority to access. In response to the telemetry ABE decryptor 375 determining a respective one of the storage partitions 385a-c that the user has authority to access based on the ciphertext included in the request from the user, the telemetry backend 310 is configured to retrieve telemetry data from the indicated storage partition and provides the retrieved telemetry data to the user, e.g., via a user interface of the client device 365.

Still referring to FIG. 3, and in accordance with additional aspects of the present invention, the telemetry handling environment 300 includes an ABE authority 380 that is configured to provision (e.g., create and distribute) the encryption keys used by the telemetry ABE encryptor 370, the decryption keys used by the telemetry ABE decryptor 375, and the ciphertexts associated with each user. In embodiments, the ABE authority 380 creates the encryption keys and the decryption keys based on defined classifications of telemetry data and creates the ciphertexts based on authorization policies for users. The ABE authority 380 may be implemented as one or more microservices in a service-oriented architecture.

In embodiments, the ciphertext associated with a user contains an RBAC authorization policy defined for the user. In embodiments, the ciphertext is an ABE ciphertext in which the authorization policy defined for the user is defined in terms of attributes associated with the user. The telemetry ABE decryptor 375 determines which one or more of the storage partitions 385a-c a user has authorization to access by determining which one or more of the plural decryption keys can decrypt the ciphertext of the user based on the authorization policy contained in the ciphertext. Different ciphertexts including different authorization policies may be associated with different users. In this manner, each respective user may utilize their respective ciphertext as a credential for accessing the telemetry data stored in one or more of the storage partitions 385a-c. In this manner, implementations provide fine grained access control of telemetry data stored in the storage partitions 385a-c based on attributes defined in an authorization policy in an ABE ciphertext associated with each user.

FIG. 4 shows an exemplary diagram of the telemetry ABE encryptor 370 of FIG. 3 in accordance with aspects of the present invention. In embodiments, the telemetry ABE encryptor 370 determines a classification of telemetry data in the telemetry pipeline 305. The classification may be based on various factors such as, but not limited to, at least one of: type of metric contained in the telemetry message; type of trace contained in the telemetry message; and type of log file contained in the telemetry message. In embodiments, after determining a classification of the telemetry message, the telemetry ABE encryptor 370 encrypts the telemetry data using a respective ABE encryption key based on the determined classification and transmits the encrypted telemetry data to the telemetry ABE decryptor 375.

In embodiments, and as shown in FIG. 4, the telemetry ABE encryptor 370 comprises a an encryption key storage module 410 and one or more encryption partitions 415a-c, each of which may comprise one or more modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform one or more of the inventive methods as described herein. The telemetry ABE encryptor 370 may include additional or fewer modules than those shown in FIG. 4. In embodiments, separate modules may be integrated into a single module. Additionally, or alternatively, a single module may be implemented as multiple modules. In one example, the telemetry ABE encryptor 370 is composed of microservices where each service is responsible for decrypting a certain classification of telemetry data. In other examples, the telemetry ABE encryptor 370 may be composed of a monolithic function, service, application, etc.

In accordance with aspects of the invention, the encryption key storage module 410 is configured to receive plural different ABE encryption keys from the ABE authority 380 and store these ABE encryption keys for use by the encryption partitions 415a-c. There may be any number “c” of encryption partitions. In embodiments, each respective one of the ABE encryption keys is associated with a respective one of the different classifications of telemetry data. The classifications may be based on various factors such as, but not limited to, at least one of: type of metric contained in the telemetry message; type of trace contained in the telemetry message; and type of log file contained in the telemetry message. Other non-limiting examples of classifications include a set of metrics representing how many times a Hypertext Transfer Protocol (HTTP) GET request is executed, and a set of log lines from a grouping of log files.

With continued reference to FIG. 4, and in accordance with aspects of the invention, each of the encryption partitions 415a-c is associated with one of the ABE encryption keys stored in the encryption key storage module 410 and is configured to identify a classification of telemetry data for which it is responsible to encrypt with its associated one of the ABE encryption keys. In various embodiments, the encryption partitions 415a-c analyze a telemetry message in the telemetry pipeline to identify telemetry data, included in the telemetry message, associated with the different classifications of telemetry data. In one example, the encryption partitions 415a-c may utilize predefined mappings that map types of telemetry data, attributes of telemetry data, and/or other parameters of telemetry data to the different classifications of telemetry data. In this manner, each respective one of the encryption partitions 415a-c may identify telemetry data that is associated with a respective classification for which the respective one of the encryption partitions 415a-c is responsible.

Still referring to FIG. 4, and in accordance with further aspects of the invention, in response to a respective one of the encryption partitions 415a-c identifying telemetry data for which it is responsible in a telemetry message, the respective one of the encryption partitions 415a-c extracts the identified telemetry data from the telemetry message and encrypts the extracted telemetry data using the respective ABE encryption key associated with the respective one of the encryption partitions 415a-c. The encryption may be performed using ciphertext-policy attribute-based encryption (CP-ABE) or key-policy attribute-based encryption (KP-ABE). In one example, when using CP-ABE, the ABE encryption key is a ciphertext and the classification of the telemetry data that a respective one of the encryption partitions 415a-c is responsible for is encoded in the ciphertext itself. In this example of using CP-ABE, if one of the encryption partitions 415a-c is associated with plural ones of the classification of telemetry data, then the encryption function associated with the ABE encryption key may be based on an access structure such that each classification of telemetry data associated with a particular one of the encryption partitions 415a-c is a required attribute for decryption (i.e., the decryption key must contain all classifications in order to decrypt). In another example, when using KP-ABE, the encryption function takes in each classification of telemetry data being encrypted in the respective one of the encryption partitions 415a-c as an attribute. In this example of using KP-ABE, the associated decryption key’s embedded access structure can then successfully decrypt the encrypted telemetry data if all classifications of telemetry data are present in the encrypted telemetry data, one classification is present, or some combination of the classifications is present (e.g., a subset of all the classifications associated with this partition). In both embodiments (e.g., CP-ABE and KP-ABE), after a respective one of the encryption partitions 415a-c encrypts the extracted telemetry data, the respective one of the encryption partitions 415a-c transmits the encrypted telemetry data to the telemetry backend 310. The transmission channel from the telemetry ABE encryptor 370 to the telemetry backend 310 may be multiplexed such that each of the encryption partitions 415a-c may transmit different encrypted telemetry data at the same time over the same channel.

FIG. 5 shows an exemplary diagram of the telemetry ABE decryptor 375 of FIG. 3 in accordance with aspects of the present invention. In embodiments, the telemetry ABE decryptor 375 receives encrypted telemetry data from the telemetry ABE encryptor 370, decrypts the encrypted telemetry data, and stores the telemetry data in a respective one of plural storage partitions 385a-c based on which respective one of plural decryption keys was used to decrypt the telemetry data.

In embodiments, and as shown in FIG. 5, the telemetry ABE decryptor 375 comprises a decryption key storage module 510 and one or more decryption partitions 515a-c, each of which may comprise one or more modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform one or more of the inventive methods as described herein. The telemetry ABE decryptor 375 may include additional or fewer modules than those shown in FIG. 4. In embodiments, separate modules may be integrated into a single module. Additionally, or alternatively, a single module may be implemented as multiple modules. In one example, the telemetry ABE decryptor 375 is composed of microservices where each service is responsible for decrypting a certain classification of telemetry data. In other examples, the telemetry ABE decryptor 375 may be composed of a monolithic function, service, application, etc.

In accordance with aspects of the invention, the decryption key storage module 510 receives and stores plural different ABE decryption keys from the ABE authority 380. In embodiments, respective ones of the ABE decryption keys are assigned to respective ones of the decryption partitions 515a-c. As noted above, the encryption by the telemetry ABE encryptor 370 may be performed using CP-ABE or KP-ABE. When using CP-ABE, each respective ABE decryption key contains the set of classifications of telemetry data for which a respective one of the decryption partitions 515a-c is responsible for decoding. When using CP-ABE, a respective one of the ABE decryption keys will successfully decrypt the encrypted telemetry data only when the respective one of the ABE decryption keys contains all the attributes encoded within the incoming ciphertext of the encrypted telemetry data. When using KP-ABE, a respective one of the ABE decryption keys will successfully decrypt the encrypted telemetry data when the respective one of the ABE decryption keys contains at least one of the attributes encoded within the encrypted telemetry data.

With continued reference to FIG. 5, and in accordance with aspects of the invention, each respective one of the decryption partitions 515a-c attempts to decrypt the encrypted telemetry data using its respective decryption key. In embodiments, in response to a respective one of the decryption partitions 515a-c successfully decrypting encrypted telemetry data using its respective decryption key, the respective one of the decryption partitions 515a-c attaches metadata to the decrypted telemetry data, where the metadata identifies a respective one of the storage partitions 385a-c with which the decrypted telemetry data is associated. In embodiments, each respective one of the decryption partitions 515a-c is associated with a respective one of the storage partitions 385a-c. The associations may be made using a predefined mapping that maps respective ones of the decryption partitions 515a-c to respective ones of the storage partitions 385a-c. In embodiments, in response to a respective one of the decryption partitions 515a-c successfully decrypting encrypted telemetry data, the telemetry backend 310 stores the telemetry data in a respective one of the storage partitions 385a-c based on the metadata that the respective one of the decryption partitions 515a-c attached to the telemetry data. In embodiments, if none of the decryption partitions 515a-c successfully decrypted the encrypted telemetry data, then the telemetry backend 310 drops the telemetry data, e.g., by not storing the telemetry data in any of the storage partitions 385a-c.

In various embodiments, the telemetry ABE decryptor 375 attempts to decrypt encrypted telemetry data (received from the telemetry ABE encryptor 370) prior to storing the telemetry data. However, in other embodiments, incoming encrypted telemetry data may be buffered in an in-memory cache or even long term storage (e.g., in a data lake) prior to the telemetry ABE decryptor 375 attempts to perform decryption. This may be done so that the telemetry backend 310 may process any received encrypted telemetry data on an as-needed basis, e.g., in response to a request from a user to access the telemetry data.

An advantage of systems and methods described herein is that the access policies that are put in place to permit a user to access the telemetry data are hidden from both the source that generated the telemetry data (e.g., sources 320, 325, 330) and also from the telemetry backend 310 used to access the telemetry data. In embodiments, this is accomplished by using a telemetry authority service (TAS) such as the ABE authority 380. In embodiments, for each defined user, the ABE authority 380 generates a ciphertext that contains, as attributes, the one or more classifications of telemetry data that the user has authorization to access. class(es) of telemetry the user has privilege to see as attributes. In embodiments, the telemetry backend 310, when it receives a user request to access (e.g., view) telemetry data, asks for ciphertext associated with the user. The telemetry backend 310, upon receiving the ciphertext from the user, tests the ciphertext against the decryption key for each one of the decryption partitions 515a-c. If decryption of the ciphertext is successful with the decryption key of one of the decryption partitions 515a-c, then the telemetry backend grants the user access to the telemetry data stored in the one of the storage partitions 385a-c that is associated with the one of the decryption partitions 515a-c. The telemetry backend 310 then retrieves the telemetry data from the one of the storage partitions 385a-c based on the metadata attached to the telemetry data during decryption of the telemetry data. In one example, each of the storage partitions 385a-c is a different storage bucket, such as an S3 bucket. In this example, when the telemetry backend 310 determines that the user has authorization to view telemetry data based on the ciphertext of the user, the telemetry backend 310 grants access to the user to view all objects in the respective bucket.

In some embodiments, each classification of telemetry data is defined as a single metric, log file, application trace, etc. Doing so provides the advantage of allowing for extremely fine-grained access control.

The telemetry ABE encryptor 370 is shown in FIG. 3 downstream of the exporters 350. In other embodiments, the telemetry ABE encryptor 370 may be at other locations in the telemetry pipeline 305, for example, between the processors 345 and the exporters 350. In this manner, the telemetry ABE encryptor 370 may be positioned in the telemetry pipeline 305 to encrypt telemetry messages within specific exported data formats. In this example, an entire telemetry message is not encrypted but, rather, the body of the message is encrypted.

As described herein, implementations of the telemetry handling environment 300 may be used to provide an enhanced telemetry pipeline 305 in which classifications of telemetry data are encrypted using ABE using respective encryption keys the respective classifications of telemetry data. The telemetry handling environment 300 may include a telemetry ABE encryptor 370 in the form of a set of microservices or a monolithic application in the telemetry backend 310, which can decrypt specific incoming telemetry messages and store each message associated with that particular decryptor partition. The telemetry handling environment 300 may include a telemetry authority service in the form of the ABE authority 380 that is decoupled from the telemetry backend 310 and that assign ciphertext (or keys) to each defined user. In this manner, the telemetry backend 310 does not need to be access policy aware.

FIG. 6 shows a flowchart of an exemplary method in accordance with aspects of the present invention. Steps of the method may be carried out in the environment of FIG. 3 and are described with reference to elements depicted in FIGS. 3-5.

At step 605, the system is configured to receive a request for telemetry data from a user, the request including an attribute-based encryption (ABE) ciphertext associated with the user. In embodiments, and as described with respect to FIGS. 3-5, the telemetry backend 310 receives a request from a user via the client device 365.

At step 610, the system is configured to attempt to decrypt the ABE ciphertext using plural different ABE decryption keys. In embodiments, and as described with respect to FIGS. 3-5, each respective one of the decryption partitions 515a-c in the telemetry ABE decryptor 375 attempts to decrypt the ABE ciphertext using its respective one of plural different ABE decryption keys.

At step 615, based on successfully decrypting the ABE ciphertext using a respective one of the plural different ABE decryption keys, the system is configured to provide the user with access to telemetry data stored in a respective one of plural storage partitions associated with the respective one of the plural different ABE decryption keys, wherein the telemetry data stored in the respective one of plural storage partitions includes the telemetry data requested by the user. In embodiments, and as described with respect to FIGS. 3-5, when one of the decryption partitions 515a-c successfully decrypts the ABE ciphertext using its ABE decryption key, the telemetry backend 310 grants the user access the one of the storage partitions 385a-c associated with the one of the decryption partitions 515a-c that successfully decrypted the ABE ciphertext.

In embodiments of the method, the request is received via a user interface of a telemetry backend, and the user is provided access to the telemetry data stored in the respective one of plural storage partitions via the telemetry backend. In embodiments of the method, the telemetry backend is associated with a telemetry pipeline. In embodiments of the method, the telemetry backend is configured to: receive encrypted telemetry data from the telemetry pipeline; attempt to decrypt the encrypted telemetry data using the plural different ABE decryption keys; and based on successfully decrypting the encrypted telemetry data using the respective one of the plural different ABE decryption keys, store the decrypted telemetry data in the respective one of the plural storage partitions.

In embodiments of the method, the telemetry pipeline is configured to create the encrypted telemetry data by encrypting extracted telemetry data using one of plural different ABE encryption keys. In embodiments of the method, the ABE authority service creates the ABE ciphertext and provides the ABE ciphertext to the user, the ABE authority service creates the plural different ABE decryption keys and provides the plural different ABE decryption keys to the telemetry backend, and the ABE authority service creates the plural different ABE encryption keys and provides the plural different ABE encryption keys to the telemetry pipeline. In embodiments of the method, the ABE authority service is separate from the telemetry backend and the telemetry pipeline.

In some embodiments of the method, the telemetry pipeline is configured to encrypt the extracted telemetry data using ciphertext-policy attribute-based encryption. In other embodiments of the method, the telemetry pipeline is configured to encrypt the extracted telemetry data using key-policy attribute-based encryption.

In embodiments of the method, the telemetry pipeline is configured to encrypt the extracted telemetry data using the one of the plural different ABE encryption keys based on identifying a classification of the extracted telemetry data.

In embodiments of the method, each of the plural different ABE decryption keys contains a respective one of plural classifications of telemetry data.

In embodiments of the method, the ABE ciphertext associated with the user contains an authorization policy defined for the user in terms of attributes associated with the user.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram of an exemplary environment in accordance with aspects of the present invention.

FIG. 4 shows a block diagram of an exemplary environment in accordance with aspects of the present invention.

FIG. 5 shows a block diagram of an exemplary environment in accordance with aspects of the present invention.

FIG. 6 shows a flowchart of an exemplary method in accordance with aspects of the present invention.

### DETAILED DESCRIPTION

Aspects of the present invention relate generally to distributed computing systems and, more specifically, to systems and methods of providing access control and protection of telemetry signals using attribute-based encryption. Telemetry signals (referred to herein as telemetry data), are pieces of information of measurements that can be used for monitoring and troubleshooting the performance of applications and platforms in distributed computing systems. A key part of successful application performance is having observability through access to data. Information technology (IT) professionals use telemetry data to determine the health and performance of applications and platforms. Telemetry data is composed primarily of outputs that are collected from logs, metrics and traces. These are often referred to as the three pillars of observability. Collecting, processing, and analyzing telemetry data from distributed applications and systems has become of great importance to enterprises for efficiently managing or troubleshooting their distributed computing systems. Software of all kinds can be instrumented in such a way that telemetry data is generated about the performance of a flow, operation, function, end-to-end network request, service call, etc.

A telemetry pipeline may comprise a set of services, components, and/or functions that ingest telemetry data, optionally transform the telemetry data, and ultimately send the telemetry data to a telemetry backend (or another pipeline). A telemetry backend may comprise a service or set of services that is responsible for post-processing and viewing received telemetry data. A telemetry backend may be a cloud provider, on-premise solution, or some combination of both. A telemetry backend may be configured to generate backend data including visualizations (e.g., dashboards), reports, and alerts based on the received telemetry data. Typically, this backend data can be introspected by human administrators via a client computing device for general purpose monitoring, observing, and understanding of overall system performance. In some examples, the backend data is passed to an automated tool for automated analysis. For example, automated analysis may include analyzing portions of telemetry data, e.g., using machine learning algorithms, to identify patterns in the data associated with an incident. Identifying such patterns is useful in developing remediation actions (e.g., patches, rules, processes, configurations, etc.) aimed at avoiding future occurrences of the incident. This type of analysis can comprise automated root cause analysis (RCA) that uses machine learning to determine a cause of the incident by analyzing portions of the telemetry data.

There is a need for enterprises to implement fine-grained access control for viewing telemetry data. For example, an organizational structure or law may require constraints to be satisfied before telemetry data containing potentially sensitive information is viewed or processed. Such potentially sensitive information may include, for example, classified information, personally identifiable information (PII), and other types of sensitive information.

Implementations of the invention address this need by using attribute-based encryption (ABE) to implement an access control system for telemetry data. ABE is a particular type of public-key encryption in which a secret cryptographic key and a ciphertext are dependent upon attributes, such as, for example, the geographic location where a user works, job title of the user, job roles of the user, resource group the user is a member of, security level of the user, and the like. In attribute-based encryption, the decryption of the ciphertext is possible only if the set of attributes of the key matches the attributes of the ciphertext. There are two main types of attribute-based encryption techniques: key-policy attribute-based encryption (KP-ABE); and ciphertext-policy attribute-based encryption (CP-ABE).

Various embodiments utilize classification of telemetry data as policy attributes for controlling access to the telemetry data via a telemetry backend. In particular embodiments, a telemetry pipeline is enhanced such that classifications of telemetry data are encrypted using respective ABE encryption keys for respective ones of the defined classifications of telemetry data. In embodiments, a set of microservices, functions, or a monolithic application in the telemetry backend decrypts specific incoming telemetry messages and associates each telemetry message with a respective partition based on the decryption. In one example, a telemetry authority service that is decoupled from the telemetry backend assigns ciphertext (or keys) to each defined user, such that each user is granted access to the telemetry data in one or more of the respective partitions based on the user’s assigned ciphertext. In this manner, the telemetry backend does not need to be access policy aware. Systems and methods described herein have the advantage of eliminating the need for a separate authentication and access control that is dependent on a vendor supplying the telemetry backend. Another advantage provided by embodiments is that permission to view telemetry data is encoded alongside the telemetry data itself. A further advantage provided by embodiments is that the access control policy is hidden from the telemetry backend (e.g., the telemetry backend may be aware of the classifications of telemetry data and which users can view the telemetry data associated with ones of the classification, but the telemetry backend cannot discern why a user has such access). An even further advantage provided by embodiments is that the telemetry data itself can be hidden from users while it remains at rest, such as when it is cached on the telemetry backend. In this manner, implementations of the invention provide an improvement in the technology of computer-based access control, particularly as pertaining to computer-based access control to telemetry data received from a telemetry pipeline.

In accordance with aspects of the invention, there is a computer-implemented method, comprising: receiving, by a processor set, a request for telemetry data from a user, the request including an attribute-based encryption (ABE) ciphertext associated with the user; attempting to decrypt the ABE ciphertext, by the processor set, using plural different ABE decryption keys; and based on successfully decrypting the ABE ciphertext using a respective one of the plural different ABE decryption keys, providing, by the processor set, the user with access to telemetry data stored in a respective one of plural storage partitions associated with the respective one of the plural different ABE decryption keys, wherein the telemetry data stored in the respective one of plural storage partitions includes the telemetry data requested by the user. In this manner, implementations of the invention provide the advantage of providing role-based access control to telemetry data using attribute-based encryption. This has the further advantage of eliminating the need for a separate authentication and access control that is dependent on a vendor supplying the telemetry backend.

In embodiments of the method, the request is received via a user interface of a telemetry backend, and the user is provided access to the telemetry data stored in the respective one of plural storage partitions via the telemetry backend. This has the advantage of enforcing the role-based access control via a telemetry backend that is accessed by user seeking access to the telemetry data.

In embodiments of the method, the telemetry backend is associated with a telemetry pipeline. This provides the advantages attendant to a telemetry pipeline, including collecting telemetry data from plural different sources and processing of the telemetry data prior to the telemetry backend.

In embodiments of the method, the telemetry backend is configured to: receive encrypted telemetry data from the telemetry pipeline; attempt to decrypt the encrypted telemetry data using the plural different ABE decryption keys; and based on successfully decrypting the encrypted telemetry data using the respective one of the plural different ABE decryption keys, store the decrypted telemetry data in the respective one of the plural storage partitions. This has the advantage of using ABE for providing fine-grained access control for plural different users to access plural different types of telemetry data.

In embodiments of the method, the telemetry pipeline is configured to create the encrypted telemetry data by encrypting extracted telemetry data using one of plural different ABE encryption keys. This has the advantage of using ABE for providing fine-grained access control for plural different types of telemetry data according to classifications of the telemetry data.

In embodiments of the method, the ABE authority service creates the ABE ciphertext and provides the ABE ciphertext to the user, the ABE authority service creates the plural different ABE decryption keys and provides the plural different ABE decryption keys to the telemetry backend, and the ABE authority service creates the plural different ABE encryption keys and provides the plural different ABE encryption keys to the telemetry pipeline. This has the advantage of the telemetry pipeline and the telemetry backend not needing to be aware of the access control policies.

In embodiments of the method, the ABE authority service is separate from the telemetry backend and the telemetry pipeline. This has the advantage of the access control policy is hidden from the telemetry pipeline and the telemetry backend (e.g., the telemetry backend may be aware of the classifications of telemetry data and which users can view the telemetry data associated with ones of the classification, but the telemetry backend cannot discern why a user has such access).

In some embodiments of the method, the telemetry pipeline is configured to encrypt the extracted telemetry data using ciphertext-policy attribute-based encryption. This has the advantage of enforcing access control based on a user having access to all classifications of the telemetry data.

In other embodiments of the method, the telemetry pipeline is configured to encrypt the extracted telemetry data using key-policy attribute-based encryption. This has the advantage of enforcing access control based on a user having access to a subset of all classifications of the telemetry data.

In embodiments of the method, the telemetry pipeline is configured to encrypt the extracted telemetry data using the one of the plural different ABE encryption keys based on identifying a classification of the extracted telemetry data. This has the advantage of providing access control to telemetry data using ABE and based on a determined classification of the telemetry data.

In embodiments of the method, each of the plural different ABE decryption keys contains a respective one of plural classifications of telemetry data. This has the advantage of providing fine-grained access control based on plural different classifications of telemetry data.

In embodiments of the method, the ABE ciphertext associated with the user contains an authorization policy defined for the user in terms of attributes associated with the user. This has the advantage of providing role-based access control to telemetry data for users based on attributes of the users.

In accordance with another aspects, there is a computer program product comprising one or more computer readable storage media having program instructions collectively stored on the one or more computer readable storage media, the program instructions executable to: receive, at a telemetry backend, a request for telemetry data from a user, the request including an attribute-based encryption (ABE) ciphertext associated with the user; attempt to decrypt the ABE ciphertext using plural different ABE decryption keys; successfully decrypt the ABE ciphertext using a respective one of the plural different ABE decryption keys; and based on the successfully decrypting the ABE ciphertext using the respective one of the plural different ABE decryption keys, provide the user with access to telemetry data stored in a respective one of plural storage partitions associated with the respective one of the plural different ABE decryption keys, wherein the telemetry data stored in the respective one of plural storage partitions includes the telemetry data requested by the user. In this manner, implementations of the invention provide the advantage of providing role-based access control to telemetry data using attribute-based encryption. This has the further advantage of eliminating the need for a separate authentication and access control that is dependent on a vendor supplying the telemetry backend.

In embodiments, each of the plural different ABE decryption keys contains a respective one of plural classifications of telemetry data. This has the advantage of providing fine-grained access control based on plural different classifications of telemetry data.

In embodiments, the telemetry backend is configured to receive encrypted telemetry data from a telemetry pipeline, the encrypted telemetry data being encrypted using one of plural different ABE encryption keys based on one of the plural classifications of telemetry data. This has the advantage of providing access control to telemetry data using ABE and based on a determined classification of the telemetry data. This has the advantage of providing fine-grained access control based on plural different classifications of telemetry data.

In embodiments, the ABE ciphertext associated with the user contains an authorization policy defined for the user in terms of attributes associated with the user. This has the advantage of providing role-based access control to telemetry data for users based on attributes of the users.

In accordance with aspects, there is a system comprising a processor set, one or more computer readable storage media, and program instructions collectively stored on the one or more computer readable storage media. The program instructions are executable to: receive, at a telemetry backend, a request for telemetry data from a user, the request including an attribute-based encryption (ABE) ciphertext associated with the user; attempt to decrypt the ABE ciphertext using plural different ABE decryption keys; successfully decrypt the ABE ciphertext using a respective one of the plural different ABE decryption keys; and based on the successfully decrypting the ABE ciphertext using the respective one of the plural different ABE decryption keys, provide the user with access to telemetry data stored in a respective one of plural storage partitions associated with the respective one of the plural different ABE decryption keys, wherein the telemetry data stored in the respective one of plural storage partitions includes the telemetry data requested by the user. In this manner, implementations of the invention provide the advantage of providing role-based access control to telemetry data using attribute-based encryption. This has the further advantage of eliminating the need for a separate authentication and access control that is dependent on a vendor supplying the telemetry backend.

In embodiments, each of the plural different ABE decryption keys contains a respective one of plural classifications of telemetry data. This has the advantage of providing fine-grained access control based on plural different classifications of telemetry data.

In embodiments, the telemetry backend is configured to receive encrypted telemetry data from a telemetry pipeline, the encrypted telemetry data being encrypted using one of plural different ABE encryption keys based on one of the plural classifications of telemetry data. This has the advantage of providing access control to telemetry data using ABE and based on a determined classification of the telemetry data. This has the advantage of providing fine-grained access control based on plural different classifications of telemetry data.

In embodiments, the ABE ciphertext associated with the user contains an authorization policy defined for the user in terms of attributes associated with the user. This has the advantage of providing role-based access control to telemetry data for users based on attributes of the users.

Implementations of the invention are necessarily rooted in computer technology. For example, the steps of encrypting and decrypting telemetry messages is computer-based and cannot be performed in the human mind. In embodiments, computer-based encryption algorithms are used encrypt a telemetry message in real time or near real time (e.g., within a matter of milliseconds or microseconds), and computer-based decryption algorithms are used decrypt an encrypted telemetry message in real time or near real time (e.g., within a matter of milliseconds or microseconds). The number and complexity of operations performed by such computer-based encryption algorithms and decryption algorithms cannot be reasonably be performed in the human mind, or with pen and paper, in real time or near real time.

It should be understood that, to the extent implementations of the invention collect, store, or employ personal information provided by or obtained from individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, con, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as telemetry signal access control code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

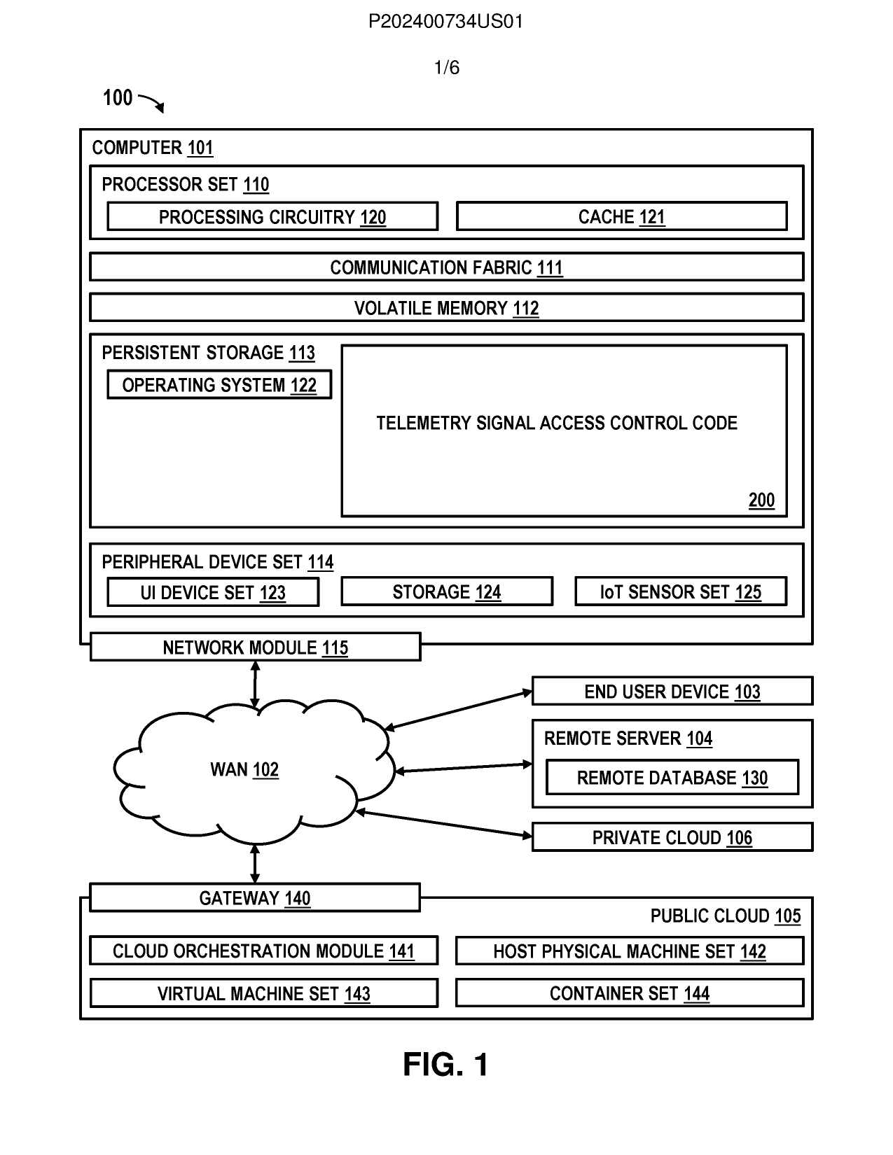

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 105, 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

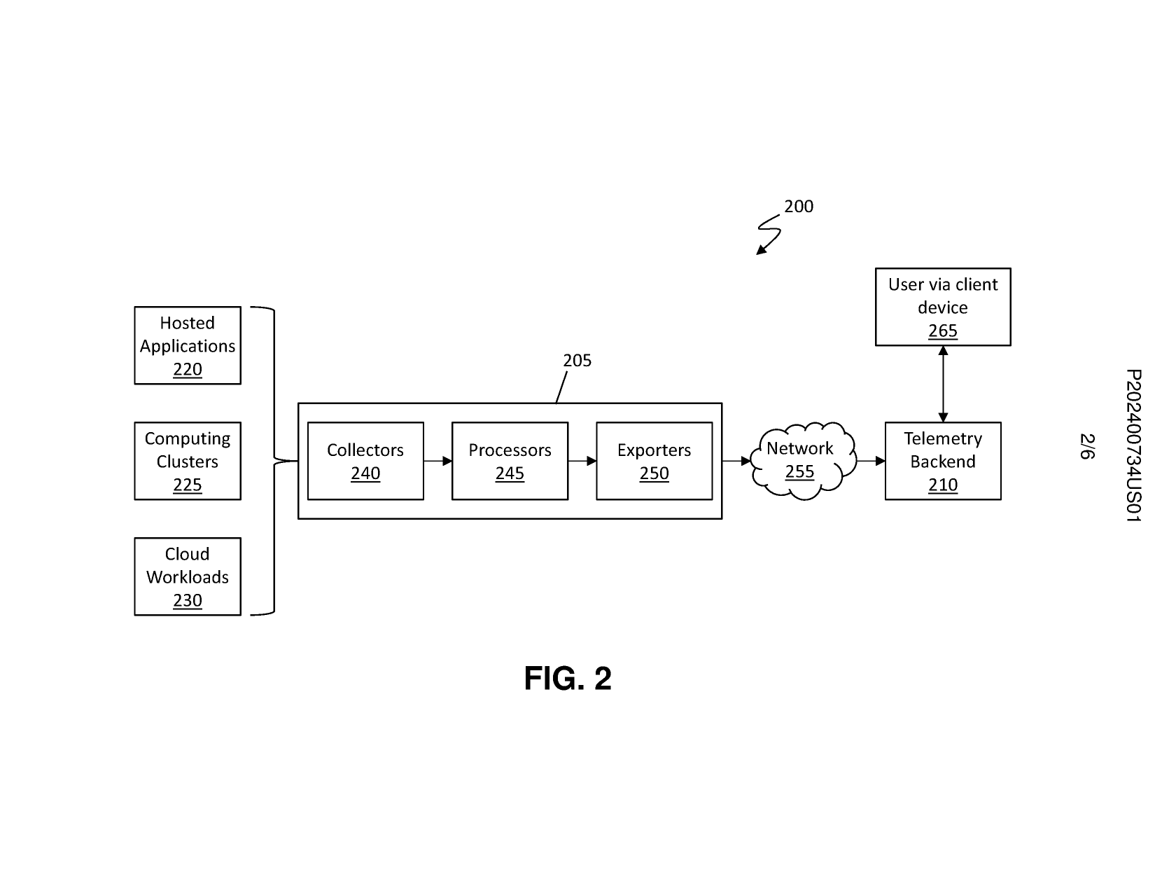

FIG. 2 shows an exemplary telemetry handling environment 200 including a telemetry pipeline 205 and a telemetry backend 210. The telemetry pipeline 205 receives telemetry data from various distributed computing sources including but not limited to hosted applications 220, computing clusters 225, and cloud workloads 230. The telemetry pipeline 205 receives telemetry data via one or more collectors 240. The telemetry pipeline 205 processes the received telemetry data using one or more processors 245, wherein the processing is performed to meet visual, automated, and/or analytical requirements. The telemetry pipeline 205 exports the processed telemetry data using one or more exporters 250 that are configured to send the data to a destination such as the telemetry backend 210 which may be one of plural different telemetry backends. The telemetry pipeline 205 may be implemented as a monolithic application or as a service-oriented architecture. In one example, the one or more collectors 240, the one or more processors 245, and the one or more exporters 250 are implemented as microservices in a service-oriented architecture. The telemetry pipeline 205 may transmit the telemetry data to the telemetry backend 210 via a network 255. The telemetry backend 210 may be configured to generate backend data including visualizations (e.g., dashboards), reports, and alerts based on the received telemetry data. This backend data can be introspected by human user 265, e.g., via a client computing device, for general purpose monitoring, observing, and understanding of overall system performance of the various sources 220, 225, and 230.

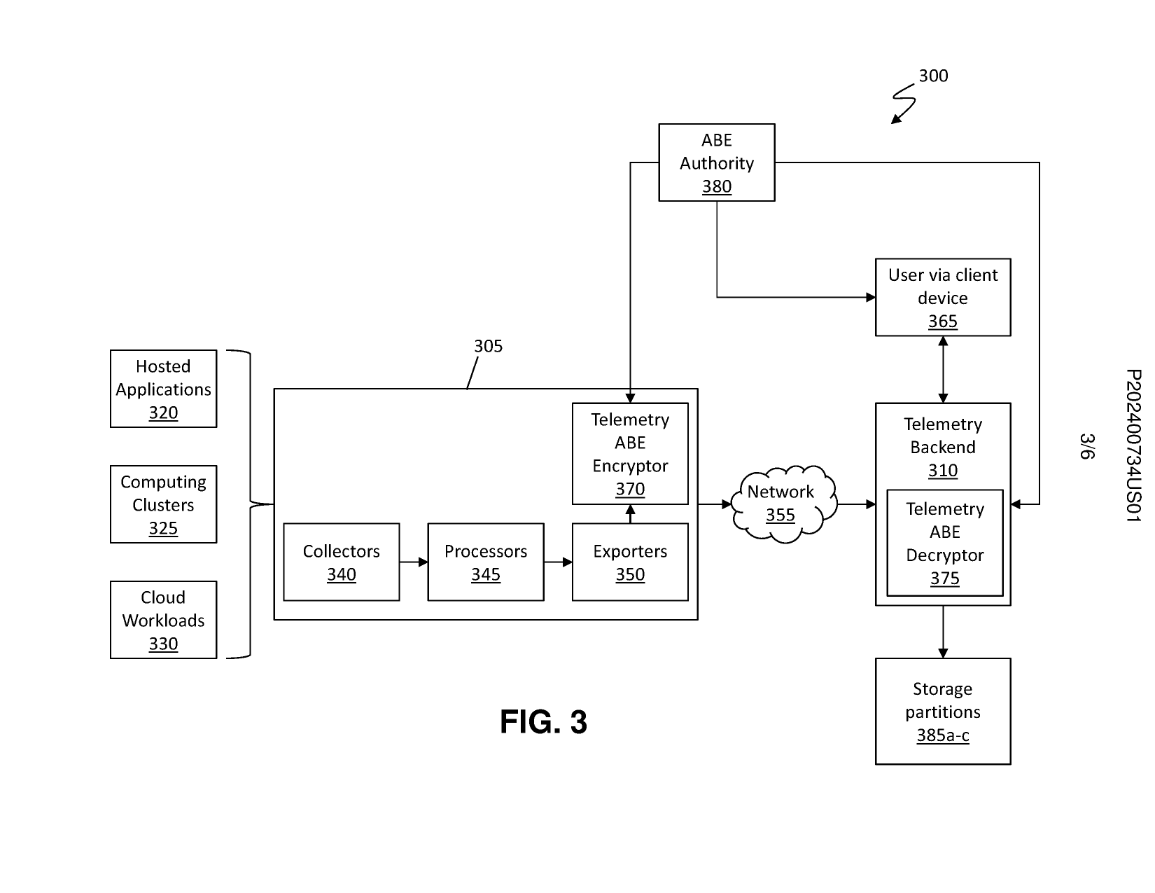

FIG. 3 shows an exemplary telemetry handling environment 300 in accordance with aspects of the present invention. The telemetry handling environment 300 includes a telemetry pipeline 305 that communicates with a telemetry backend 310 via a network 355. There may be any number of telemetry backends 310, each comprising a service or set of services running on a computer device and configured to generate backend data as described herein. In embodiments, the telemetry pipeline 305 receives telemetry data from various distributed computing sources including but not limited to hosted applications 320, computing clusters 325, and cloud workloads 330. In various examples, the telemetry data is automatically generated by one or more system monitoring tools that monitor one or more of the sources 320, 325, and 330, and includes at least one of logs, metrics, and traces. Logs are files that record events, warnings, and errors as they occur within a software environment. Metrics are quantifiable measurements that reflect the health and performance of applications or infrastructure. A trace is data that tracks an application request as it flows through the various parts of an application.

In embodiments the telemetry pipeline 305 includes one or more collectors 340, one or more processors 345, one or more exporters 350, and a telemetry ABE encryptor 370. The one or more collectors 340 are configured to collect telemetry data from one or more of the sources 320, 325, and 330 and pass the collected telemetry data to the one or more processors 345. The one or more processors 345 are configured to process the telemetry data, for example, by adjusting or modifying the telemetry data to meet visual, automated, and/or analytical requirements. The one or more exporters 350 are configured to receive the processed telemetry data from the one or more processors 345 and provide the processed telemetry data to the telemetry ABE encryptor 370. In accordance with aspects of the invention, the telemetry ABE encryptor 370 is configured to determine a classification of telemetry data, encrypt the telemetry data using a respective ABE encryption key based on the determined classification, and transmit the encrypted telemetry data to the telemetry backend 310. The telemetry pipeline 305 may be implemented as a monolithic application or as a service-oriented architecture. In one example, the one or more collectors 340, the one or more processors 345, the one or more exporters 350, and the telemetry ABE encryptor 370 are implemented as microservices in a service-oriented architecture.

With continued reference to FIG. 3, and in accordance with aspects of the present invention, the telemetry backend 310 comprises or communicates with a telemetry ABE decryptor 375. In embodiments, the telemetry ABE decryptor 375 is configured to receive the encrypted telemetry data from the telemetry ABE encryptor 370 and attempt to decrypt the encrypted telemetry data using plural decryption keys. The telemetry ABE decryptor 375 is further configured to, upon successfully decrypting the encrypted telemetry data using a respective one of the plural decryption keys, store the decrypted telemetry data in a respective one a plural storage partitions 385a-c associated with the respective one of the plural decryption keys. In this manner, different classifications of telemetry data are stored in different ones of the storage partitions 385a-c based on the classifications.

Still referring to FIG. 3, and in accordance with additional aspects of the present invention, the telemetry backend 310 is configured to receive a request for telemetry data from a user via a client device 365, wherein the request includes an attribute-based encryption (ABE) ciphertext associated with the user. The client device 365 may comprise one or more of the EUD 103 of FIG. 1. In embodiments, the telemetry ABE decryptor 375 is configured to use the ciphertext from the user and the plural decryption keys to determine a respective one of the storage partitions 385a-c that the user has authority to access. In response to the telemetry ABE decryptor 375 determining a respective one of the storage partitions 385a-c that the user has authority to access based on the ciphertext included in the request from the user, the telemetry backend 310 is configured to retrieve telemetry data from the indicated storage partition and provides the retrieved telemetry data to the user, e.g., via a user interface of the client device 365.

Still referring to FIG. 3, and in accordance with additional aspects of the present invention, the telemetry handling environment 300 includes an ABE authority 380 that is configured to provision (e.g., create and distribute) the encryption keys used by the telemetry ABE encryptor 370, the decryption keys used by the telemetry ABE decryptor 375, and the ciphertexts associated with each user. In embodiments, the ABE authority 380 creates the encryption keys and the decryption keys based on defined classifications of telemetry data and creates the ciphertexts based on authorization policies for users. The ABE authority 380 may be implemented as one or more microservices in a service-oriented architecture.

In embodiments, the ciphertext associated with a user contains an RBAC authorization policy defined for the user. In embodiments, the ciphertext is an ABE ciphertext in which the authorization policy defined for the user is defined in terms of attributes associated with the user. The telemetry ABE decryptor 375 determines which one or more of the storage partitions 385a-c a user has authorization to access by determining which one or more of the plural decryption keys can decrypt the ciphertext of the user based on the authorization policy contained in the ciphertext. Different ciphertexts including different authorization policies may be associated with different users. In this manner, each respective user may utilize their respective ciphertext as a credential for accessing the telemetry data stored in one or more of the storage partitions 385a-c. In this manner, implementations provide fine grained access control of telemetry data stored in the storage partitions 385a-c based on attributes defined in an authorization policy in an ABE ciphertext associated with each user.

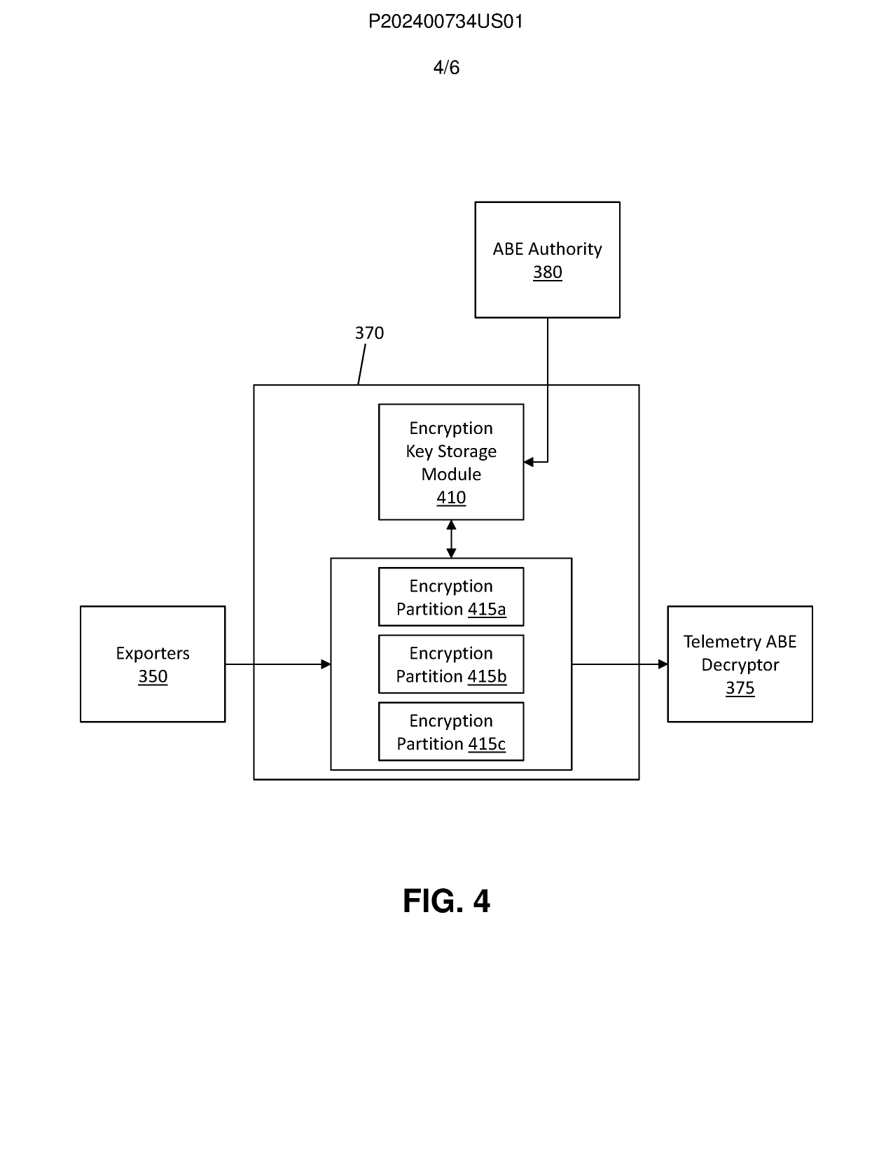

FIG. 4 shows an exemplary diagram of the telemetry ABE encryptor 370 of FIG. 3 in accordance with aspects of the present invention. In embodiments, the telemetry ABE encryptor 370 determines a classification of telemetry data in the telemetry pipeline 305. The classification may be based on various factors such as, but not limited to, at least one of: type of metric contained in the telemetry message; type of trace contained in the telemetry message; and type of log file contained in the telemetry message. In embodiments, after determining a classification of the telemetry message, the telemetry ABE encryptor 370 encrypts the telemetry data using a respective ABE encryption key based on the determined classification and transmits the encrypted telemetry data to the telemetry ABE decryptor 375.

In embodiments, and as shown in FIG. 4, the telemetry ABE encryptor 370 comprises a an encryption key storage module 410 and one or more encryption partitions 415a-c, each of which may comprise one or more modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform one or more of the inventive methods as described herein. The telemetry ABE encryptor 370 may include additional or fewer modules than those shown in FIG. 4. In embodiments, separate modules may be integrated into a single module. Additionally, or alternatively, a single module may be implemented as multiple modules. In one example, the telemetry ABE encryptor 370 is composed of microservices where each service is responsible for decrypting a certain classification of telemetry data. In other examples, the telemetry ABE encryptor 370 may be composed of a monolithic function, service, application, etc.

In accordance with aspects of the invention, the encryption key storage module 410 is configured to receive plural different ABE encryption keys from the ABE authority 380 and store these ABE encryption keys for use by the encryption partitions 415a-c. There may be any number “c” of encryption partitions. In embodiments, each respective one of the ABE encryption keys is associated with a respective one of the different classifications of telemetry data. The classifications may be based on various factors such as, but not limited to, at least one of: type of metric contained in the telemetry message; type of trace contained in the telemetry message; and type of log file contained in the telemetry message. Other non-limiting examples of classifications include a set of metrics representing how many times a Hypertext Transfer Protocol (HTTP) GET request is executed, and a set of log lines from a grouping of log files.

With continued reference to FIG. 4, and in accordance with aspects of the invention, each of the encryption partitions 415a-c is associated with one of the ABE encryption keys stored in the encryption key storage module 410 and is configured to identify a classification of telemetry data for which it is responsible to encrypt with its associated one of the ABE encryption keys. In various embodiments, the encryption partitions 415a-c analyze a telemetry message in the telemetry pipeline to identify telemetry data, included in the telemetry message, associated with the different classifications of telemetry data. In one example, the encryption partitions 415a-c may utilize predefined mappings that map types of telemetry data, attributes of telemetry data, and/or other parameters of telemetry data to the different classifications of telemetry data. In this manner, each respective one of the encryption partitions 415a-c may identify telemetry data that is associated with a respective classification for which the respective one of the encryption partitions 415a-c is responsible.

Still referring to FIG. 4, and in accordance with further aspects of the invention, in response to a respective one of the encryption partitions 415a-c identifying telemetry data for which it is responsible in a telemetry message, the respective one of the encryption partitions 415a-c extracts the identified telemetry data from the telemetry message and encrypts the extracted telemetry data using the respective ABE encryption key associated with the respective one of the encryption partitions 415a-c. The encryption may be performed using ciphertext-policy attribute-based encryption (CP-ABE) or key-policy attribute-based encryption (KP-ABE). In one example, when using CP-ABE, the ABE encryption key is a ciphertext and the classification of the telemetry data that a respective one of the encryption partitions 415a-c is responsible for is encoded in the ciphertext itself. In this example of using CP-ABE, if one of the encryption partitions 415a-c is associated with plural ones of the classification of telemetry data, then the encryption function associated with the ABE encryption key may be based on an access structure such that each classification of telemetry data associated with a particular one of the encryption partitions 415a-c is a required attribute for decryption (i.e., the decryption key must contain all classifications in order to decrypt). In another example, when using KP-ABE, the encryption function takes in each classification of telemetry data being encrypted in the respective one of the encryption partitions 415a-c as an attribute. In this example of using KP-ABE, the associated decryption key’s embedded access structure can then successfully decrypt the encrypted telemetry data if all classifications of telemetry data are present in the encrypted telemetry data, one classification is present, or some combination of the classifications is present (e.g., a subset of all the classifications associated with this partition). In both embodiments (e.g., CP-ABE and KP-ABE), after a respective one of the encryption partitions 415a-c encrypts the extracted telemetry data, the respective one of the encryption partitions 415a-c transmits the encrypted telemetry data to the telemetry backend 310. The transmission channel from the telemetry ABE encryptor 370 to the telemetry backend 310 may be multiplexed such that each of the encryption partitions 415a-c may transmit different encrypted telemetry data at the same time over the same channel.

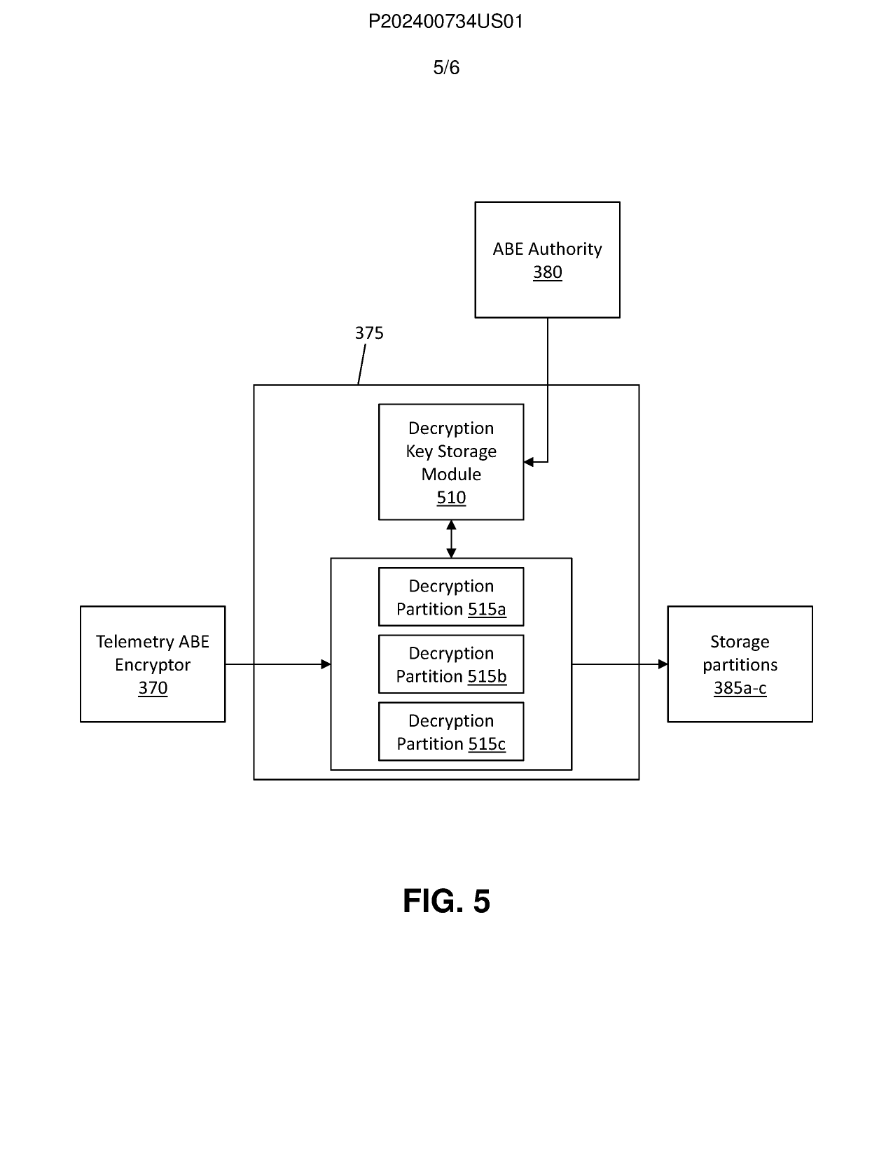

FIG. 5 shows an exemplary diagram of the telemetry ABE decryptor 375 of FIG. 3 in accordance with aspects of the present invention. In embodiments, the telemetry ABE decryptor 375 receives encrypted telemetry data from the telemetry ABE encryptor 370, decrypts the encrypted telemetry data, and stores the telemetry data in a respective one of plural storage partitions 385a-c based on which respective one of plural decryption keys was used to decrypt the telemetry data.

In embodiments, and as shown in FIG. 5, the telemetry ABE decryptor 375 comprises a decryption key storage module 510 and one or more decryption partitions 515a-c, each of which may comprise one or more modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform one or more of the inventive methods as described herein. The telemetry ABE decryptor 375 may include additional or fewer modules than those shown in FIG. 4. In embodiments, separate modules may be integrated into a single module. Additionally, or alternatively, a single module may be implemented as multiple modules. In one example, the telemetry ABE decryptor 375 is composed of microservices where each service is responsible for decrypting a certain classification of telemetry data. In other examples, the telemetry ABE decryptor 375 may be composed of a monolithic function, service, application, etc.

In accordance with aspects of the invention, the decryption key storage module 510 receives and stores plural different ABE decryption keys from the ABE authority 380. In embodiments, respective ones of the ABE decryption keys are assigned to respective ones of the decryption partitions 515a-c. As noted above, the encryption by the telemetry ABE encryptor 370 may be performed using CP-ABE or KP-ABE. When using CP-ABE, each respective ABE decryption key contains the set of classifications of telemetry data for which a respective one of the decryption partitions 515a-c is responsible for decoding. When using CP-ABE, a respective one of the ABE decryption keys will successfully decrypt the encrypted telemetry data only when the respective one of the ABE decryption keys contains all the attributes encoded within the incoming ciphertext of the encrypted telemetry data. When using KP-ABE, a respective one of the ABE decryption keys will successfully decrypt the encrypted telemetry data when the respective one of the ABE decryption keys contains at least one of the attributes encoded within the encrypted telemetry data.

With continued reference to FIG. 5, and in accordance with aspects of the invention, each respective one of the decryption partitions 515a-c attempts to decrypt the encrypted telemetry data using its respective decryption key. In embodiments, in response to a respective one of the decryption partitions 515a-c successfully decrypting encrypted telemetry data using its respective decryption key, the respective one of the decryption partitions 515a-c attaches metadata to the decrypted telemetry data, where the metadata identifies a respective one of the storage partitions 385a-c with which the decrypted telemetry data is associated. In embodiments, each respective one of the decryption partitions 515a-c is associated with a respective one of the storage partitions 385a-c. The associations may be made using a predefined mapping that maps respective ones of the decryption partitions 515a-c to respective ones of the storage partitions 385a-c. In embodiments, in response to a respective one of the decryption partitions 515a-c successfully decrypting encrypted telemetry data, the telemetry backend 310 stores the telemetry data in a respective one of the storage partitions 385a-c based on the metadata that the respective one of the decryption partitions 515a-c attached to the telemetry data. In embodiments, if none of the decryption partitions 515a-c successfully decrypted the encrypted telemetry data, then the telemetry backend 310 drops the telemetry data, e.g., by not storing the telemetry data in any of the storage partitions 385a-c.

In various embodiments, the telemetry ABE decryptor 375 attempts to decrypt encrypted telemetry data (received from the telemetry ABE encryptor 370) prior to storing the telemetry data. However, in other embodiments, incoming encrypted telemetry data may be buffered in an in-memory cache or even long term storage (e.g., in a data lake) prior to the telemetry ABE decryptor 375 attempts to perform decryption. This may be done so that the telemetry backend 310 may process any received encrypted telemetry data on an as-needed basis, e.g., in response to a request from a user to access the telemetry data.

An advantage of systems and methods described herein is that the access policies that are put in place to permit a user to access the telemetry data are hidden from both the source that generated the telemetry data (e.g., sources 320, 325, 330) and also from the telemetry backend 310 used to access the telemetry data. In embodiments, this is accomplished by using a telemetry authority service (TAS) such as the ABE authority 380. In embodiments, for each defined user, the ABE authority 380 generates a ciphertext that contains, as attributes, the one or more classifications of telemetry data that the user has authorization to access. class(es) of telemetry the user has privilege to see as attributes. In embodiments, the telemetry backend 310, when it receives a user request to access (e.g., view) telemetry data, asks for ciphertext associated with the user. The telemetry backend 310, upon receiving the ciphertext from the user, tests the ciphertext against the decryption key for each one of the decryption partitions 515a-c. If decryption of the ciphertext is successful with the decryption key of one of the decryption partitions 515a-c, then the telemetry backend grants the user access to the telemetry data stored in the one of the storage partitions 385a-c that is associated with the one of the decryption partitions 515a-c. The telemetry backend 310 then retrieves the telemetry data from the one of the storage partitions 385a-c based on the metadata attached to the telemetry data during decryption of the telemetry data. In one example, each of the storage partitions 385a-c is a different storage bucket, such as an S3 bucket. In this example, when the telemetry backend 310 determines that the user has authorization to view telemetry data based on the ciphertext of the user, the telemetry backend 310 grants access to the user to view all objects in the respective bucket.

In some embodiments, each classification of telemetry data is defined as a single metric, log file, application trace, etc. Doing so provides the advantage of allowing for extremely fine-grained access control.

The telemetry ABE encryptor 370 is shown in FIG. 3 downstream of the exporters 350. In other embodiments, the telemetry ABE encryptor 370 may be at other locations in the telemetry pipeline 305, for example, between the processors 345 and the exporters 350. In this manner, the telemetry ABE encryptor 370 may be positioned in the telemetry pipeline 305 to encrypt telemetry messages within specific exported data formats. In this example, an entire telemetry message is not encrypted but, rather, the body of the message is encrypted.

As described herein, implementations of the telemetry handling environment 300 may be used to provide an enhanced telemetry pipeline 305 in which classifications of telemetry data are encrypted using ABE using respective encryption keys the respective classifications of telemetry data. The telemetry handling environment 300 may include a telemetry ABE encryptor 370 in the form of a set of microservices or a monolithic application in the telemetry backend 310, which can decrypt specific incoming telemetry messages and store each message associated with that particular decryptor partition. The telemetry handling environment 300 may include a telemetry authority service in the form of the ABE authority 380 that is decoupled from the telemetry backend 310 and that assign ciphertext (or keys) to each defined user. In this manner, the telemetry backend 310 does not need to be access policy aware.

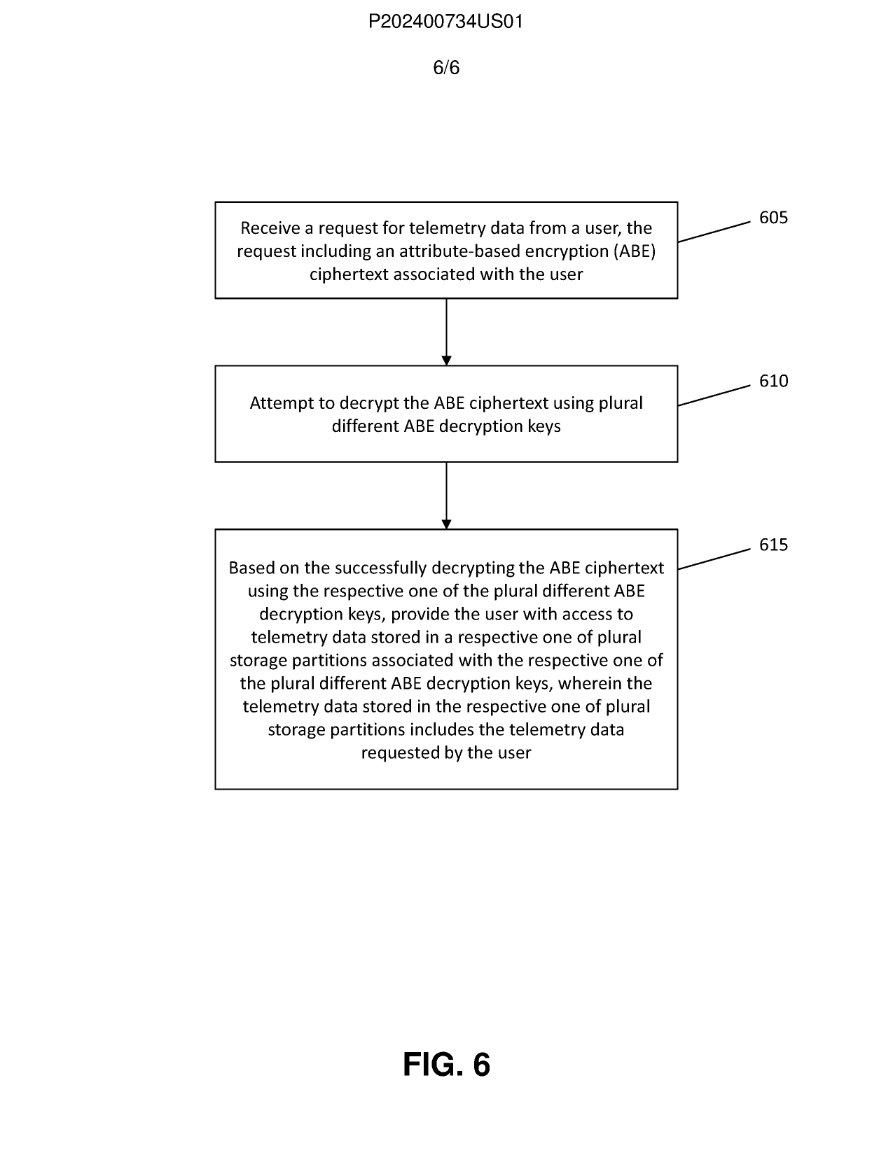

FIG. 6 shows a flowchart of an exemplary method in accordance with aspects of the present invention. Steps of the method may be carried out in the environment of FIG. 3 and are described with reference to elements depicted in FIGS. 3-5.

At step 605, the system is configured to receive a request for telemetry data from a user, the request including an attribute-based encryption (ABE) ciphertext associated with the user. In embodiments, and as described with respect to FIGS. 3-5, the telemetry backend 310 receives a request from a user via the client device 365.

At step 610, the system is configured to attempt to decrypt the ABE ciphertext using plural different ABE decryption keys. In embodiments, and as described with respect to FIGS. 3-5, each respective one of the decryption partitions 515a-c in the telemetry ABE decryptor 375 attempts to decrypt the ABE ciphertext using its respective one of plural different ABE decryption keys.

At step 615, based on successfully decrypting the ABE ciphertext using a respective one of the plural different ABE decryption keys, the system is configured to provide the user with access to telemetry data stored in a respective one of plural storage partitions associated with the respective one of the plural different ABE decryption keys, wherein the telemetry data stored in the respective one of plural storage partitions includes the telemetry data requested by the user. In embodiments, and as described with respect to FIGS. 3-5, when one of the decryption partitions 515a-c successfully decrypts the ABE ciphertext using its ABE decryption key, the telemetry backend 310 grants the user access the one of the storage partitions 385a-c associated with the one of the decryption partitions 515a-c that successfully decrypted the ABE ciphertext.

In embodiments of the method, the request is received via a user interface of a telemetry backend, and the user is provided access to the telemetry data stored in the respective one of plural storage partitions via the telemetry backend. In embodiments of the method, the telemetry backend is associated with a telemetry pipeline. In embodiments of the method, the telemetry backend is configured to: receive encrypted telemetry data from the telemetry pipeline; attempt to decrypt the encrypted telemetry data using the plural different ABE decryption keys; and based on successfully decrypting the encrypted telemetry data using the respective one of the plural different ABE decryption keys, store the decrypted telemetry data in the respective one of the plural storage partitions.

In embodiments of the method, the telemetry pipeline is configured to create the encrypted telemetry data by encrypting extracted telemetry data using one of plural different ABE encryption keys. In embodiments of the method, the ABE authority service creates the ABE ciphertext and provides the ABE ciphertext to the user, the ABE authority service creates the plural different ABE decryption keys and provides the plural different ABE decryption keys to the telemetry backend, and the ABE authority service creates the plural different ABE encryption keys and provides the plural different ABE encryption keys to the telemetry pipeline. In embodiments of the method, the ABE authority service is separate from the telemetry backend and the telemetry pipeline.

In some embodiments of the method, the telemetry pipeline is configured to encrypt the extracted telemetry data using ciphertext-policy attribute-based encryption. In other embodiments of the method, the telemetry pipeline is configured to encrypt the extracted telemetry data using key-policy attribute-based encryption.

In embodiments of the method, the telemetry pipeline is configured to encrypt the extracted telemetry data using the one of the plural different ABE encryption keys based on identifying a classification of the extracted telemetry data.

In embodiments of the method, each of the plural different ABE decryption keys contains a respective one of plural classifications of telemetry data.

In embodiments of the method, the ABE ciphertext associated with the user contains an authorization policy defined for the user in terms of attributes associated with the user.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, a request for telemetry data from a user, the request including an attribute-based encryption (ABE) ciphertext associated with the user;
attempting to decrypt the ABE ciphertext, by the processor set, using plural different ABE decryption keys; and
based on successfully decrypting the ABE ciphertext using a respective one of the plural different ABE decryption keys, providing, by the processor set, the user with access to telemetry data stored in a respective one of plural storage partitions associated with the respective one of the plural different ABE decryption keys, wherein the telemetry data stored in the respective one of plural storage partitions includes the telemetry data requested by the user.

2. The computer-implemented method of claim 1, wherein:
the request is received via a user interface of a telemetry backend; and
the user is provided access to the telemetry data stored in the respective one of plural storage partitions via the telemetry backend.

3. The computer-implemented method of claim 2, wherein the telemetry backend is associated with a telemetry pipeline.

4. The computer-implemented method of claim 3, wherein the telemetry backend is configured to:
receive encrypted telemetry data from the telemetry pipeline;
attempt to decrypt the encrypted telemetry data using the plural different ABE decryption keys; and
based on successfully decrypting the encrypted telemetry data using the respective one of the plural different ABE decryption keys, store the decrypted telemetry data in the respective one of the plural storage partitions.

5. The computer-implemented method of claim 4, wherein the telemetry pipeline is configured to create the encrypted telemetry data by encrypting extracted telemetry data using one of plural different ABE encryption keys.

6. The computer-implemented method of claim 5, wherein:
an ABE authority service creates the ABE ciphertext and provides the ABE ciphertext to the user;
the ABE authority service creates the plural different ABE decryption keys and provides the plural different ABE decryption keys to the telemetry backend; and
the ABE authority service creates the plural different ABE encryption keys and provides the plural different ABE encryption keys to the telemetry pipeline.

7. The computer-implemented method of claim 6, wherein the ABE authority service is separate from the telemetry backend and the telemetry pipeline.

8. The computer-implemented method of claim 5, wherein the telemetry pipeline is configured to encrypt the extracted telemetry data using ciphertext-policy attribute-based encryption.

9. The computer-implemented method of claim 5, wherein the telemetry pipeline is configured to encrypt the extracted telemetry data using key-policy attribute-based encryption.

10. The computer-implemented method of claim 5, wherein the telemetry pipeline is configured to encrypt the extracted telemetry data using the one of the plural different ABE encryption keys based on identifying a classification of the extracted telemetry data.

11. The computer-implemented method of claim 1, wherein each of the plural different ABE decryption keys contains a respective one of plural classifications of telemetry data.

12. The computer-implemented method of claim 1, wherein the ABE ciphertext associated with the user contains an authorization policy defined for the user in terms of attributes associated with the user.

13. A computer program product comprising one or more computer readable storage media having program instructions collectively stored on the one or more computer readable storage media, the program instructions executable to:
receive, at a telemetry backend, a request for telemetry data from a user, the request including an attribute-based encryption (ABE) ciphertext associated with the user;
attempt to decrypt the ABE ciphertext using plural different ABE decryption keys;
successfully decrypt the ABE ciphertext using a respective one of the plural different ABE decryption keys; and
based on the successfully decrypting the ABE ciphertext using the respective one of the plural different ABE decryption keys, provide the user with access to telemetry data stored in a respective one of plural storage partitions associated with the respective one of the plural different ABE decryption keys, wherein the telemetry data stored in the respective one of plural storage partitions includes the telemetry data requested by the user.

14. The computer program product of claim 13, wherein each of the plural different ABE decryption keys contains a respective one of plural classifications of telemetry data.

15. The computer program product of claim 14, wherein the telemetry backend is configured to receive encrypted telemetry data from a telemetry pipeline, the encrypted telemetry data being encrypted using one of plural different ABE encryption keys based on one of the plural classifications of telemetry data.

16. The computer program product of claim 13, wherein the ABE ciphertext associated with the user contains an authorization policy defined for the user in terms of attributes associated with the user.

17. A system comprising:
a processor set, one or more computer readable storage media, and program instructions collectively stored on the one or more computer readable storage media, the program instructions executable to:
receive, at a telemetry backend, a request for telemetry data from a user, the request including an attribute-based encryption (ABE) ciphertext associated with the user;
attempt to decrypt the ABE ciphertext using plural different ABE decryption keys;
successfully decrypt the ABE ciphertext using a respective one of the plural different ABE decryption keys; and
based on the successfully decrypting the ABE ciphertext using the respective one of the plural different ABE decryption keys, provide the user with access to telemetry data stored in a respective one of plural storage partitions associated with the respective one of the plural different ABE decryption keys, wherein the telemetry data stored in the respective one of plural storage partitions includes the telemetry data requested by the user.

18. The system of claim 17, wherein each of the plural different ABE decryption keys contains a respective one of plural classifications of telemetry data.

19. The system of claim 18, wherein the telemetry backend is configured to receive encrypted telemetry data from a telemetry pipeline, the encrypted telemetry data being encrypted using one of plural different ABE encryption keys based on one of the plural classifications of telemetry data.

20. The system of claim 17, wherein the ABE ciphertext associated with the user contains an authorization policy defined for the user in terms of attributes associated with the user.
